(19) United States
(12) Patent Application Publication
(10) Pub. No.: US 2005/0249280 A1
(43) Pub. Date: Nov. 10, 2005

(54) Image data compression apparatus, enencoder electronic equipment, and image data compression method

(76) Inventors: Yoshimasa Kondo, Matsumoto (JP); Kyoichi Osada, Kofu (JP)

Correspondence Address: HARNESS, DICKEY & PIERCE, P.L.C., P.O. BOX 828, BLOOMFIELD HILLS, MI, 48303, US

(21) Appl. No.: 11/124,812

(22) Filed: May 9, 2005

(30) Foreign Application Priority Data
May 10, 2004 (JP) 2004-139753

(51) Int. Cl. H04N 7/12

(52) U.S. Cl. 375/240.03; 375/240.12; 375/240.18; 375/240.2

(57) ABSTRACT

An image data compression apparatus comprises a quantization section which quantizes image data in frame units, a FIFO buffer section where quantization data of a plurality of frame portions is stored, an encoded data generating section, which reads quantization data of a one frame portion from the FIFO buffer section asynchronously writing in the FIFO buffer section, and generating encoded data which encoded quantization data, and a rate control section which changes a quantization step of the quantization section per frame to change a data size of the encoded data. The rate control section changes the quantization step based on a predictive data size by obtaining a predictive data size of encoded data preceding by one frame from the quantization data which is preceding by the one frame.

### RELATED APPLICATIONS

This application claims priority to Japanese Patent Application No. 2004-139753 filed May 10, 2004 which is hereby expressly incorporated by reference herein in its entirety.

### BACKGROUND

1. Technical Field

This invention relates to an image data compression apparatus, an encoder, electronic equipment and an image data compression method.

2. Related Art

As an encoding system for multi-media information such as image data of still images or dynamic images and voice data, MPEG-4 (Moving Picture Experts Group Phase 4) is standardized. Mobile equipment in recent years has realized encoding and decoding of image data in accordance with this MPEG-4, thus making it possible to reproduce dynamic images and transmit/receive via a network.

Under the MPEG-4 standards, it is necessary to generate compressed data which consists of image data of dynamic images encoded under a fixed rate. However, when compressing image data of dynamic images, as a result of dependence on contents of image data, compression efficiency considerably fluctuates. In MPEG-4 Visual Part (Recommendations ISO/IEC 14496-2:1999(E) Annex L), there is described a rate control method which generates compressed data at a fixed rate by controlling a specified generated encode amount so as to keep this fluctuation within a specified range.

When performing encode processing (compression) of MPEG-4, it is considered that a series of processing is all executed by hardware. However, in this case, a circuit size grows to make it difficult to miniaturize when ICs are incorporated (semiconductor device, integrated circuit). Particularly, in a case of mobile equipment such as mobile phones, demand for smaller equipment cannot be met.

On the other hand, it is considered that a series of processing of encoding is executed all by using software. But, in this case, a load on a CPU (Central Processing Unit) processing software increases. Consequently, there is a limit for the CPU to spend time on other processing, thus reducing performance of equipment mounted with this CPU. Also, an increase in CPU processing time is induced, causing power consumption to grow. Especially, in mobile equipment such as mobile phones, demand for lowering power consumption to curtail battery wear cannot be met.

Now, it is considered to let hardware and software to share a series of processing of encoding. However, as a result of analysis by the present inventor, in regard to the series of processing of encoding, when optimizing the sharing of hardware and software, it was discovered that the rate control method disclosed in MPEG-4 Visual Part (Recommendations ISO/IEC 14496-2:1999(E) Annex L) could not be executed. Namely, when the processing of the hardware having a processing rate and the processing of the software having another processing rate are to be shared, a buffer that can absorb a difference in the processing rates is needed. But, it was discovered that should this buffer be set up, it would become impossible to execute the above-mentioned rate control method, thereby creating a problem regarding the compression processing of the image data that optimization of the sharing of hardware and software and realization of the accurate rate control are not compatible with each other.

The present invention has been made in view of the above-mentioned technical problem. It is an object thereof to provide an image data compression apparatus, an encoder, electronic equipment and an image data compression method wherein, regarding the compression processing of the image data, optimization of the sharing of hardware and software and realization of the accurate rate control are compatible with each other.

### SUMMARY

To solve the above-mentioned problem, the present invention is an image data compression apparatus for compressing image data, comprising: a quantization section for quantizing image data in frame units; an FIFO buffer section for buffering quantization data of a plurality of frame portions quantized by the quantization section; a encoded data generating section for writing in the FIFO section, reading quantization data of a one frame portion from the FIFO buffer section asynchronously, and generating encoded data which encoded the quantization data; and a rate control section which changes a data size of encoded data by changing a quantization step of the quantization section, wherein: the rate control section obtains a predictive data size of encoded data, which is preceding by one frame, from a data size of quantization data preceding a current frame by the one frame, and relating to the image compression apparatus which changes the quantization step based on the predictive data size.

In the present invention, the FIFO section is provided between the quantization section and the encoded data generating section. By doing so, it is possible to operate processes of the quantization section and the encoded data generating section asynchronously and in parallel. And, when controlling a generating rate of the encoded data by the encoded data generating section, the rate control section obtains the predictive data size of encoded data generated by the encoded data generating section and changes the quantization step based on the predictive data size.

By this means, if, as a result of configuring such that the processes of the quantization section and the encoded data generating section operate asynchronously, the rate control method disclosed in MPEG-4 Visual Part (Recommendations ISO/IEC 14496-2:1999(E) Annex L) cannot be executed, the generating rate of the encoded data can be controlled and the encoded data which is image data compressed at a fixed rate can be generated. Moreover, such rate control can be performed accurately.

Further, the image data compression apparatus according to the present invention comprises a count register in which count data corresponding to a number of times of accessing the FIFO buffer section is held, wherein: the rate control section obtains the predictive data size and changes the quantization step based on the predictive data size.

According to the present invention, since it is possible to obtain, with a simple configuration, information equivalent to the data size of the quantization data, it is possible to provide the image data compression apparatus which can obtain the above-mentioned effect with a simpler configuration.

Further, in the image data compression apparatus according to the present invention, the predictive data size may be a data size obtained by subjecting a data size of the quantization data, which is preceding by the one frame, to linear transformation.

Still further, in the image data compression apparatus according to the present invention, the linear transformation may be a transformation which used a coefficient corresponding to an encoding efficiency of the encoded data generating section.

Furthermore, in the image data compression apparatus according to the present invention, the linear transformation may be further a transformation which performs correction of a header size portion to be added to the encoded data.

In the present invention, focus is placed on the fact that the data size of the quantization data and the data size of the encoded data are approximately in a linear relationship, whereas through a linear transformation formula expressing this linear relationship, it is possible to obtain the predictive data size. This enables accurate rate control to be realized without increasing a processing load.

Further, the image data compression apparatus according to the present invention comprises a quantization table for memorizing a quantization step value, wherein: the rate control section obtains a quantization parameter based on the predictive data size, and changes the quantization step by performing quantization through use of a product of the quantization parameter multiplied by the quantization step value.

Further, the image data compression apparatus according to the present invention may comprise a discrete cosine transform section supplying the image data subjected to discrete cosine transform to the quantization section in frame units.

Further, the image data compression apparatus according to the present invention comprises a hardware processing section processing image data of a dynamic image through hardware; and a software processing section generating encoded data by encoding quantization data, which is read from the FIFO buffer section, through software, wherein: the hardware processing section consists essentially of the quantization section and the rate control section.

Dynamic image data which has been quantized has predominantly large amounts of zero data, and by comparison to data prior to quantization, in many cases, kinds of information on the amount of data are significantly little. In addition, a load of operation itself for encoding is small. Hence, even if the software processing section performs processing with little information volumes and light operation load, a load of that processing is small. Conversely, the majority of quantization processing have large information volumes and complicated operation, so that there is a heavy load for processing with the software. Further, these entail processing of the heavy load, but if they are standardized, there is little need of a change. Also, since there is much repeated processing, it is suited to processing in the hardware processing section. Also, since the amount of data after processing in the hardware processing section is little, there is little amount of data to be transmitted from the hardware processing section to the software processing and a transmission load is lightened. Further, there is the FIFO buffer section interposed between software processing and hardware processing section, so that software processing and hardware processing can be carried out in parallel. Furthermore, by using software processing for one purpose and hardware processing for another purpose, it is possible to realize both miniaturizing the apparatus and reducing power consumption.

Further, in the image data compression apparatus according to the present invention, the hardware processing section outputs a differential between input image data of the current frame and past image data, which is preceding the current frame by one frame, as dynamic vector information; discrete cosine transform is performed with respect to the dynamic vector information and outputted as the image data to the quantization section; and the past image data is generated based on inverse quantization data obtained in the quantization step as inverse quantization with respect to the quantization data.

Further, in the image data compression apparatus according to the present invention, the software processing section can encode quantization data read from the FIFO buffer section into variable-length encodes.

Further, in the image data compression apparatus according to the present invention, the software processing section performs scanning for permutating quantization data read from the FIFO buffer section, thus making it possible to encode results of the scanning into variable-lengthen codes.

Further, in the image data compression apparatus according to the present invention, the software processing section obtains a DC component and an AC component from quantization data read from the FIFO buffer section, performs scanning for permutating the DC component and the AC component, thus making it possible to encode the results of the scanning into the variable-length encodes.

Further, the present invention is an encoder performing compression processing with respect to image data, comprising: an image input interface performing interface processing to input image data; a quantization section quantizing the image data in frame units; an FIFO buffer section wherein the quantization data of a portion of a plurality of frames quantized by the quantization section is subjected to buffering; and a host interface performing interface processing with a host reading quantization data stored in the FIFO buffer section asynchronously with writing in the FIFO buffer section, wherein: the host obtains a predictive data size of encoded data preceding by one frame a data size of quantization data preceding a current frame by one frame, the quantization section relating to the encoder which quantizes by means of the quantization step that is changed based on the predictive data size.

Further, the encoder according to the present invention comprises: a count register in which count data corresponding to a number of times of accessing the FIFO buffer section is held, wherein: the host reads the count data held in the count register; and the predictive data size is obtained from the count data.

According to the present invention, for example, it is possible to let the encoder and the host to share the encode processing to compress image data of a dynamic image from an image pickup section. Consequently, it is possible to execute in parallel quantization of the above-mentioned encode processing and generation of encoded data. Further, by using the encoder for one purpose and the host for another purpose, it is possible to realize both miniaturizing the apparatus and reducing power consumption.

Further, the present invention relates to electronic equipment including the image data compression apparatus mentioned either of the above.

Still further, the present invention relates to electronic equipment including the encoder mentioned above.

According to the present invention, it is possible to provide electronic equipment in which optimization of the sharing of hardware and software is compatible with realization of the accurate rate control.

Furthermore, the present invention is an image data compression method for compressing image data, and quantization data wherein image data is quantized in frame units, obtaining a predictive data size of encoded data, which is preceding by one frame, from a data size of quantization data preceding a current frame by the one frame, changing the quantization step for quantizing the image data based on the predictive data size, quantizing image data of the current frame in the quantization step, and relating to the image data compression method which changes the data size of encoded data that encoded the image data.

### BRIEF DESCRIPTION OF THE DRAWINGS

FIGS. 1A and B are diagrams to explain encode processing and decode processing of MPEG-4;

FIG. 2 is a diagram to explain a macro block;

FIG. 3 is a diagram to explain an example of a DCT coefficient;

FIG. 4 is a diagram to explain an example of a quantization table;

FIG. 5 is a diagram to explain an example of a quantized DCT coefficient;

FIG. 6 is a diagram to explain model equations used in the rate control method;

FIG. 7 is a flow sheet to explain an example of rate control processing using the model equations in FIG. 6;

FIG. 8 is a block diagram outlining configuration of an image data compression apparatus of the present embodiment;

FIG. 9 is a diagram to explain a predictive data size;

FIG. 10 is a diagram to explain the rate control method in the present embodiment;

FIG. 11 is a schematic diagram of motion timing of the rate control method shown in FIG. 10;

FIG. 12 is a flow sheet of the first half of an example of calculation processing of a quantization parameter;

FIG. 13 is a flow sheet of the second half of an example of calculation processing of the quantization parameter;

FIG. 14 is a diagram to explain a variable used in calculation processing of the quantization parameter;

FIG. 15 is a flow sheet of an example of calculation processing of the value of a bit number used for encoding;

FIG. 16 is a diagram to explain quantization processing of the present embodiment;

FIG. 17 is a detailed functional block diagram of the image data compression apparatus of the present embodiment;

FIG. 18 is a diagram to a hardware configuration example of the image data compression apparatus of FIG. 17;

FIG. 19 is a flow sheet of an example of interrupt receiving processing carried out by the host;

FIG. 20 is a flow sheet of an example of ME interrupt processing;

FIG. 21 is a flow sheet of an example of encode completion interrupt processing;

FIG. 22 is a diagram to show a relationship between the count data and the predictive data size;

FIG. 23 is a block diagram outlining configuration of the image data compression apparatus in the comparison example of the present embodiment;

FIG. 24 is a diagram to explain the rate control method in the comparison example;

FIG. 25 is a schematic diagram of motion timing of the rate control method shown in FIG. 24;

FIG. 26 is a diagram to show simulation results showing an example of changes in empty capacity of a VBV buffer in the comparison example

FIG. 27 is a diagram to show simulation results showing an example of changes in empty capacity of the VBV buffer in the present embodiment;

FIG. 28 is a block diagram of a configuration example of a display controller in the present embodiment; and

FIG. 29 is a block diagram of a configuration example of electronic equipment to which the display controller of FIG. 28 is applied.

### DETAILED DESCRIPTION

Embodiments of the present invention will be described below with reference to the drawings. It is to be understood that the embodiments to be described below are not unjustly limited to the contents of the present invention in claims. Further, all configuration and arrangements to be described below do not necessarily represent the essential composing elements of the present invention.

1. MPEG-4

First, encode processing of MPEG-4 will be briefly explained. Also, decode processing to extend compressed data encoded by this encode processing will also be described.

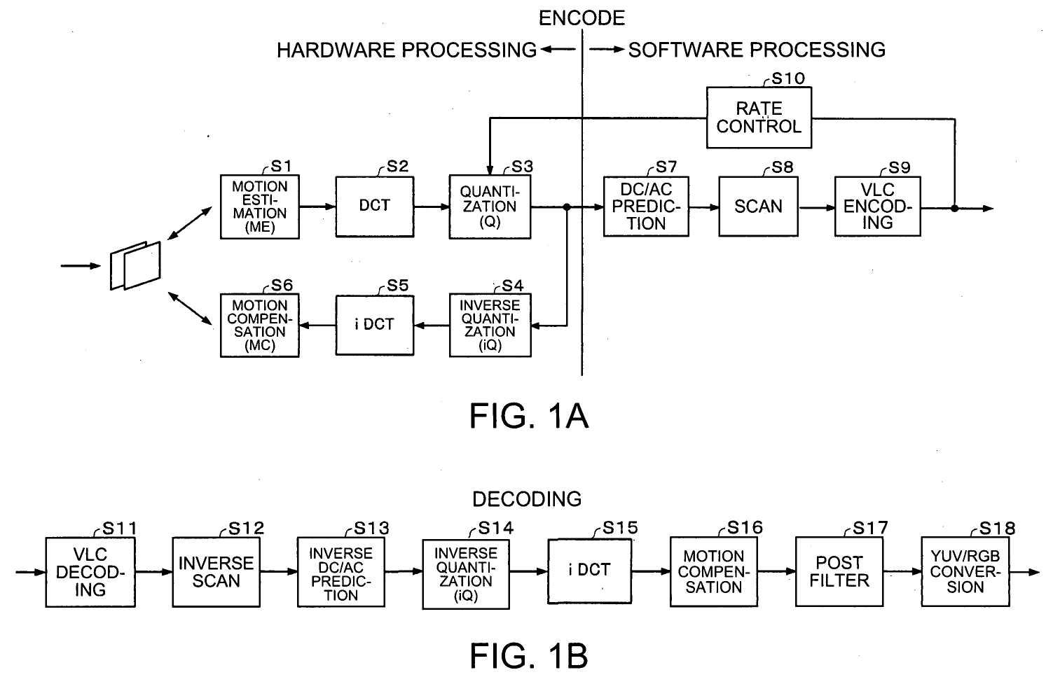

FIGS. 1A and B shows an explanatory diagram of encode processing and decode processing of MPEG-4. Since details of this processing is explained in, for example, JPEG&MPEG: Illustrated Image Compression written by Hiroshi Ochi and Hideo Kuroda, published by Nihon Jitsugyo Publishing Co., only processing regarding the present invention will be mainly described.

In the encode processing shown in FIG. 1A, first, motion estimation (ME) between images of two continuous frames is carried out (step SI). Specifically, a differential of the same pixels between images of two frames is obtained. Since the differential becomes 0 in a changeless image area between images of two frames, the information volume can be made small. In addition to zero data of this image area, a differential (plus and minus components) of an image area having a change between images of two frames becomes information after motion estimation.

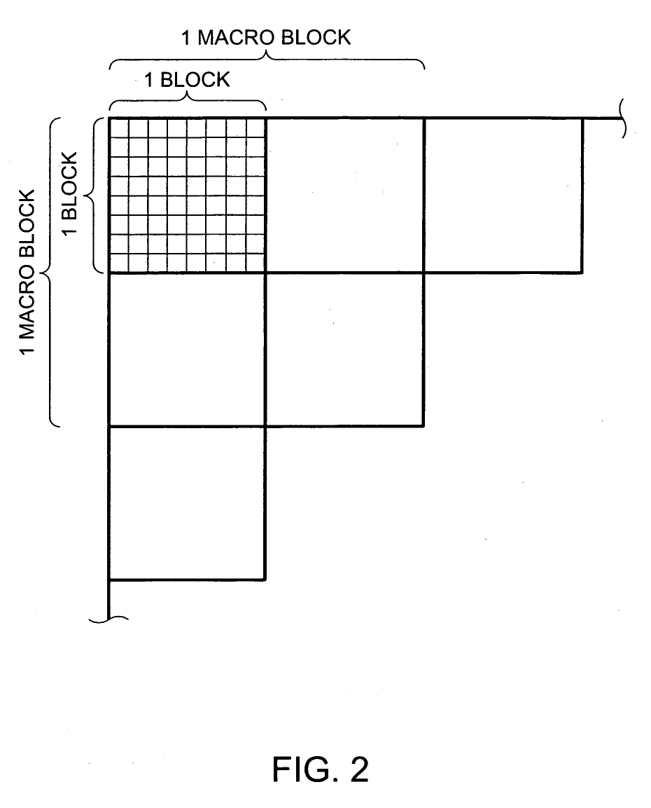

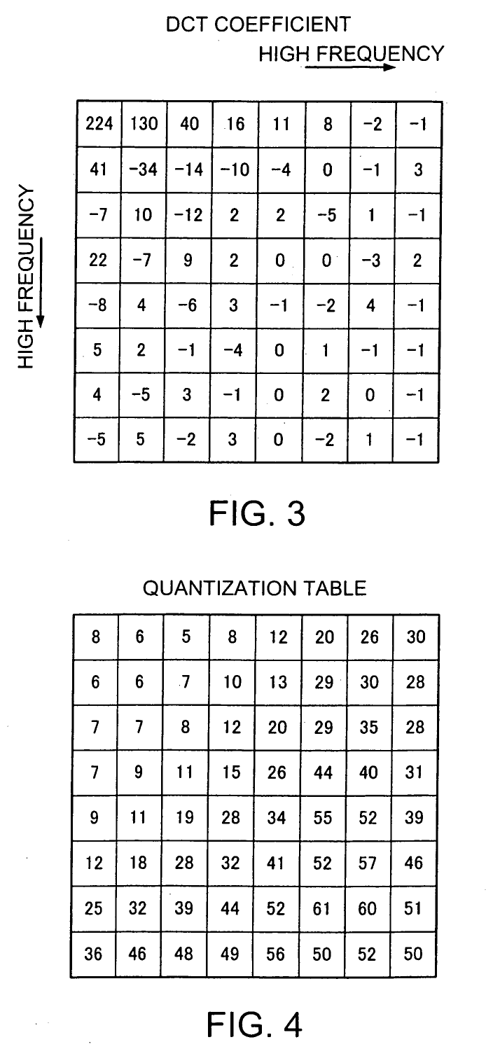

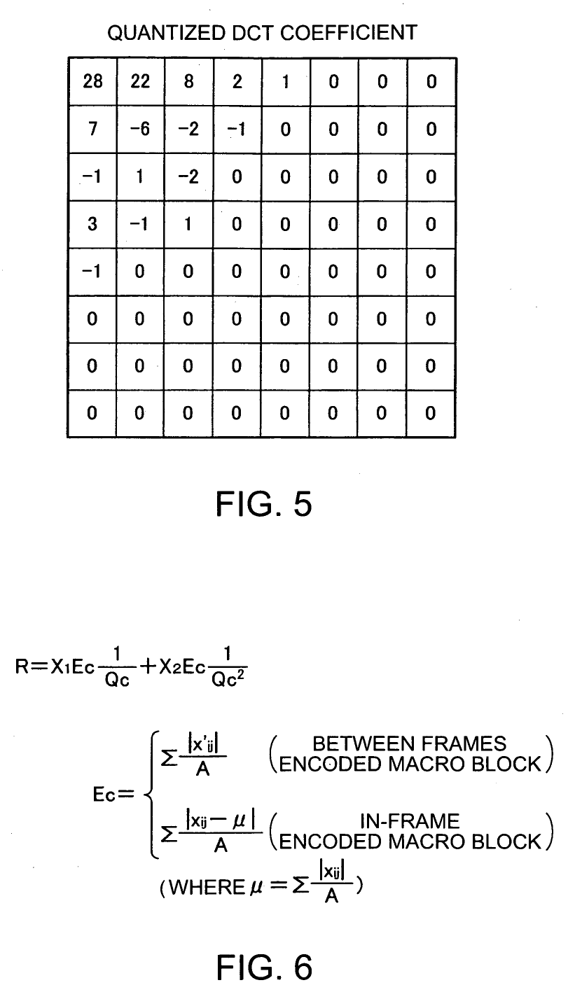

Next, discrete cosine transform (DCT) is carried out (step S2). This DCT is calculated in one block units of 8 pixels×8 pixels shown in FIG. 2, and a DCT coefficient is obtained per block. The DCT coefficient after DCT is a shading change of an image in one block expressed by entire brightness (DC component) and spatial frequency (AC component). FIG. 3 shows an example of the DCT coefficient in one block of 8 pixels×8 pixels (FIG. 5E on page 116 of the above-mentioned book quoted). The DCT coefficient of the upper left-hand corner shows the DC component, while the DCT coefficient other than that shows the AC component. It should be noted that even if the high frequency component of the AC component is omitted, there is little effect on image recognition.

Next, quantization of the DCT coefficient is carried out (step S3). This quantization is carried out to reduce the information volume by dividing each DCT coefficient in one block by a quantization step value at a corresponding position in the quantization table. For example, there is shown in FIG. 5 the DCT coefficient in one block which is the DCT coefficient of FIG. 3 quantized by using the quantization table of FIG. 4 (FIG. 5I and FIG. 5J on page 117 of the above-mentioned book quoted). As shown in FIG. 5, in particular, if the DCT coefficient of the high frequency component is divided by the quantization step value and any value under the decimal point is rounded off, then, nearly all becomes zero data, with a significant decrease in the information volume.

For this encode processing, a feedback route becomes necessary so as to carry out the above-mentioned ME between the current frame and a frame next to the current frame. In this feedback route, as shown in FIG. 1A, inverse quantization (iQ), inverse DCT, and motion compensation (MC) are carried out (steps S4-S6). It should be noted that while detailed motion of MC will be omitted, this processing is carried out in macro block units of 16 pixels×16 pixels shown in FIG. 2.

In the present embodiment, processing in the above-mentioned steps S1-S6 are carried out by the hardware.

DC/AC (direct current/alternating current component) predictive processing carried out in step S7 of FIG. 1A and scan processing carried out in step S8 are both necessary processing for enhancing encoding efficiency of variable-length encode (VLC) of step S9. This is because for encoding of VLC of step S9, it is necessary to determine an order of encoding by encoding a differential between adjacent blocks in regard to the DC component and scanning (may be referred to as zigzag scan) from a low side to a high side of frequency in the block in regard to the AC component.

Encoding to VLC in step S9 may also be called “entropy encoding.” It is encoding, as an encoding principle, to express that which has high frequency of appearance in a low encode. For this entropy encoding, Huffman encoding is employed.

And in step S9, using results of step S7 and step S8, the differential between adjacent blocks in regard to the DC component is encoded, and the DCT coefficient value is encoded in order of being scanned from the low frequency side to the high frequency side in regard to the AC component.

At this point, image data is such that a generated information volume fluctuates depending on complexity of its image and intensity of motion. To absorb this fluctuation and to transmit at a fixed transmission rate, it is necessary to control the generated encode amount. This is the rate control of step S10. For the rate control, a buffer memory is typically provided, and the information volume stored is monitored to keep the generated information volume so that this buffer memory may not overflow. Specifically, quantization property at step S3 is made rough to reduce the number of bit expressing the DCT coefficient value.

In the present embodiment, processing of the above-mentioned S7-S10 is realized by hardware which read software.

FIG. 1B shows decode processing of image data compressed by the encode processing of FIG. 1A. This decode processing is accomplished by subjecting the encode processing of FIG. 1A to inverse processing in an inverse order. It should be noted that a “post filter” in FIG. 1B is a filter for deleting a block noise. Further, “YUV/RGB transformation” in FIG. 1B refers to converting a post filer output to an RGB format from a YUV format.

2. Rate Control

Next, in regard to the rate control to be carried out in step S10 shown in FIG. 1A, a technique stated in MPEG-4 Visual Part (Recommendations ISO/IEC 14496-2:1999(E) Annex L) will be briefly described. This technique changes a quantization parameter when encoding. By changing the quantization parameter, the quantization step for quantization (step S3) shown in FIG. 1 As changed to alter quantization property so as to control a generated encode amount (data size).

In this technique, a quantization parameter Qc is set up per frame, and control of a generated encode amount R, when one frame is encoded, is controlled. At this time, the quantization parameter Qc is obtained according to model equations shown in FIG. 6.

In FIG. 6, R shows a generated encode amount when one frame is encoded, Qc shows a quantization parameter, Ec shows frame complexity, and X₁, and X₂ show the parameters of the present model. The frame complexity Ec uses an average of absolute values of pixels subjected to encoding. At this point, as for an encoded macro-block between frames, the frame complexity Ec is obtained, after ME, as a value of dividing a total sum of absolute values of differential value xᵢⱼ between the current frame and a frame preceding the current frame by an area A. As for the encoded macro-block in the frame, it is obtained as a value of dividing the total sum of absolute values of differential value |xᵢⱼ−μ| between the current frame and a reference value μ by the area A. It should be noted that the reference value μ may be set as an average of all pixels in the macro-block.

In this manner, in FIG. 6, the generated encode amount is made into a model by a quadratic equation of reciprocals of the frame complexity and the quantization parameter.

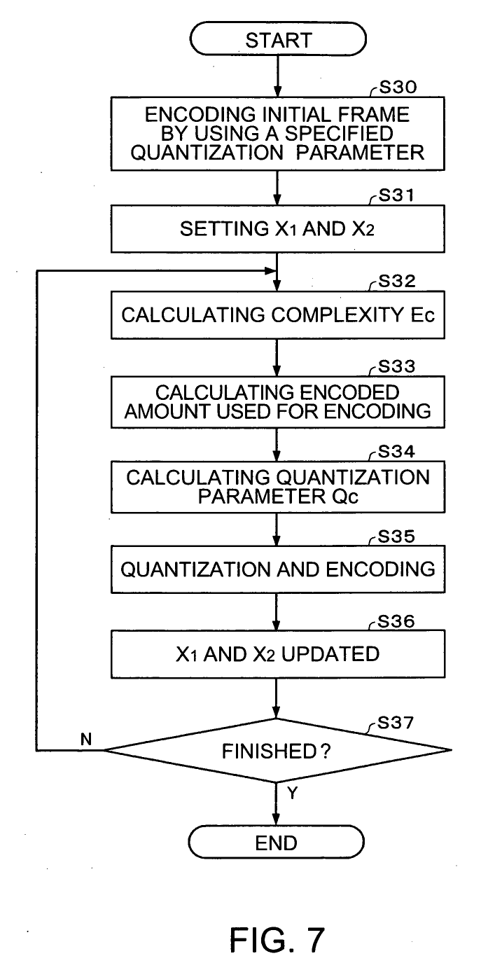

In FIG. 7, there is shown an example of a processing flow of the rate control using the model equations shown in FIG. 6.

First, an initial frame is encoded by using a specified quantization parameter (step S30). Next, initial values of model parameters x₁ and x₂ are set (step S31). Subsequently, the current frame complexity Ec is calculated (step S32). The complexity Ec may be obtained by using the equations shown in FIG. 6. And the encode amount used for encoding is obtained based on the remaining usable encode amount and the encode amount used in the preceding frame (step S33).

Further, the model parameters X₁ and X₂, and the complexity Ec obtained in step S32 are set in the model equations shown in FIG. 6. Also, a value obtained by subtracting a number of bits from among a number of bits used in the preceding frame, which is other than information such as a header and a vector to move, from the encode amount, which is obtained in step S33 to be used in encoding, is set in the model equations shown in FIG. 6 as the generated encode amount R when encoding one frame. And, a quadratic equation having the parameter shown in FIG. 6 as Qc is solved to obtain the quantization parameter Qc (step S34).

Next, the quantization and encoding of the frame are carried out (step S35) by using the quantization parameter Qc obtained in step S34, and the model parameters X₁ and X₂ are obtained from the model equations shown in FIG. 6 and updated (step S37:N) based on the quantization parameter of the frame which was encoded one frame preceding the current frame, the generated encode amount and the like.

When this processing flow is completed under a specified condition (step S37:Y), a series of processing ends (END); and when not completed (step S37:N), a return is made to step S32. Processing mentioned above is carried out per frame.

In the rate control method stated in MPEG-4 Visual Part (Recommendations ISO/IEC 14496-2:1999(E) Annex L), in this manner, it is necessary to reflect a result of encoding, which is preceding by one frame, on the encoding of a next frame.

3. Image Data Compression Apparatus

Now, the present embodiment provides an image data compression apparatus which makes the series of encode processing as described above to be shared by the hardware and the software, thereby optimizing such sharing.

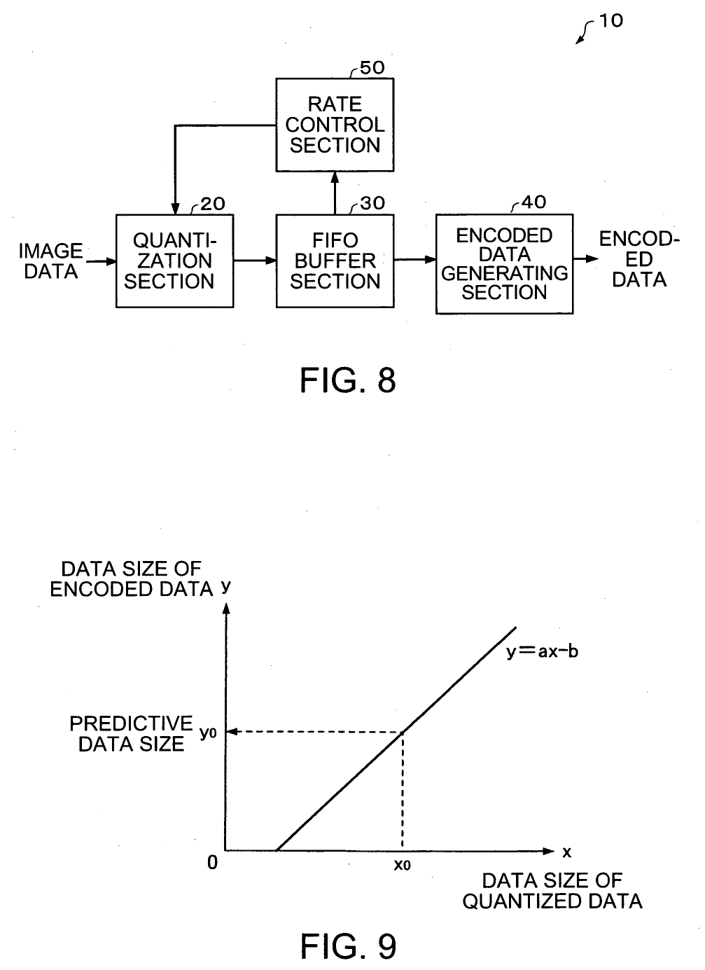

In FIG. 8, there is shown a block diagram outlining a configuration of the image data compression apparatus of the present embodiment.

An image data compression apparatus 10 in the present embodiment comprises a quantization section 20. The quantization section 20 carries out processing of step S3 shown in FIG. 1A. The quantization section 20 quantizes image data in frame units. Namely, the quantization section 20 quantizes image data in frame units and generates quantization data. The image data herein is able to show, for example, by means of a DCT coefficient after DCT processing of step S2 shown in FIG. 1A. In this case, the DCT coefficient shown in FIG. 3 is divided by a quantization step value of a quantization table shown in FIG. 4 and quantized as shown in FIG. 5.

The image data compression apparatus 10 comprises a FIFO buffer section 30. In the FIFO buffer section 30, quantization data of portions of a plurality of frames, which are quantized by the quantization section 20, is subjected to buffering. The quantization data outputted from the quantization section 20 in frame units is sequentially written into the FIFO buffer section 30, and the FIFO buffer section 30 functions as a first-in, first-out memory circuit.

The image data compression apparatus 10 comprises an encoded data generating section 40. The encoded data generating section 40 reads quantization data of a one frame portion from the FIFO buffer section 30 and generates encoded data which is the quantization data encoded. This encoded data generating section 40 reads quantization data of the one frame portion from the FIFO buffer section 30 asynchronously with writing in the FIFO buffer section 30.

In this manner, by setting up the FIFO buffer section 30 between the quantization section 20 and the encoded data generating section 401, the hardware is made to bear a burden of processing of the quantization section 20 which has a heavy processing load. While software processing realizes encode processing of the encoded data generating section 40 having a light processing load, both processing can be made in parallel.

In the following, the quantization section 20 is realized, for example, by a high-speed hardware, and while it is described as the encoded data generating section 40 being realized, for example, by low-speed software processing, it is not limited to this. The present embodiment may be applied in a case where the encoded data generating section 40 reads the quantization data from the FIFO buffer section 30 asynchronously with writing in the FIFO buffer section 30. Consequently, the quantization section 20 may be realized by, for example, a high-speed hardware, and the encoded data generating section 40 may be realized by, for example, a low-speed hardware. Or the quantization section 20 and the encoded data generating section 40 may be realized by hardware reading software, so that asynchronous processing may be mutually made.

The image data compression apparatus 10 comprises a rate control section 50. The rate control section 50 predicts, from a data size of quantization data preceding the current frame by one frame, a data size of encoded data preceding by the one frame to obtain a predictive data size, and changes a quantization step based on the predictive data size. As apparent from FIG. 5, increasing the quantization step will increase zero data of a quantized DCT coefficient. On the other hand, reducing the quantization step will decrease zero data of the quantized DCT coefficient. The quantization data in which the zero data increases or decreases in this manner is written in the FIFO buffer section 30. As a result, the quantization data read from the FIFO buffer section 30 can be changed corresponding to the quantization parameter including a size of the encoded data which the encoded data generating section 40 encoded.

As mentioned above, in the rate control method stated in MPEG-4 Visual Part (Recommendations ISO/IEC 14496-2:1999(E) Annex L), it is necessary to reflect the encoding result preceding by one frame in a next frame encoding. However, when it is arranged such that quantization of the quantization section 20 and encoding of the encoded data generating section 40 are shared by the hardware and the software, mutual processing is asynchronously carried out. Consequently, the quantization data read by the FIFO buffer section 30 may sometimes become data of a frame preceding by more than two frames of data to be quantized by the quantization section 20. Hence, it does not become possible to realize the rate control method stated in MPEG-4 Visual Part (Recommendations ISO/IEC 14496-2:1999(E) Annex L) which reflects the encoding result preceding by one frame in encoding the next frame.

Now, in the present embodiment, the rate control section 50 obtains the predictive data size of the encoded data preceding the current frame by one frame as mentioned above and carries out rate control based on the predictive data size. At this time, in the present embodiment, focus is put on the following property to obtain the predictive data size.

In FIG. 9, there is shown an explanatory diagram of a relationship between the data size of the quantization data and the data size of the encoded data. The quantization data herein is data read from the quantization section 20 and data generated in step S3 in FIG. 1 A. Also, the encoded data is data, which encoded the quantization data by the encoded data generating section 40, and data generated in step S9 in FIG. 1A.

As shown in FIG. 9, there is a linear relationship between the data size of the quantization data and the data size of the encoded data. Namely, from the following equation (1), where x is the data size of the quantization data and y is the data size of the encoded data, with x as a variable, y can be obtained in approximation.
y=ax−b (a and b positive integers) (1)

Accordingly, it is possible to obtain y as a predictive value yₒ of a data size of the encoded data by subjecting data size x₀ of the quantization data to linear transformation. In equation (1), a is a coefficient corresponding to encoding efficiency of the encoded data generating section 40. This coefficient is determined corresponding to processing property of the encoded data generating section 40. To be further specific, this coefficient can be said to be a compression coefficient of Huffman encode processing for the sake of Huffman encoding carried out in the encoded data generating section 40.

Also, in equation (1), b is a value corresponding to a data size of header information of the encoded data generated by the encoded data generating section 40. For example, if the encoded data is stream data of MPEG-4, the data size of the header information of MPEG-4 is set as b. By this means, linear transformation of equation (1) can be said as further transformation to correct a header size portion to be added to the encoded data.

The a and b of equation (1) mentioned above are obtained, for example, with respect to image data of a plurality of kinds by statistically processing a relationship between the data size of the quantization data and the data size of the encoded data.

By reflecting the predictive size obtained in this manner as the encoding result preceding by one frame in a next frame encoding, the rate control method stated in MPEG-4 Visual Part (Recommendations ISO/IEC 14496-2:1999(E) Annex L) is carried out. Regarding the compression processing of the image data, this enables optimization of the sharing of hardware and software and realization of more accurate rate control to be compatible with each other.

Now, in FIG. 8, while it is arranged such as to obtain the predictive data size from the data size of the quantization data, it is not limited to this. It is also possible to obtain the predictive data size from the data size of the quantization data and equivalent information.

In the following, as the data size of the quantization data and equivalent information, a number of access times to the FIFO buffer section 30 of each frame (a number of times of writing or a number of times of reading) is used. By writing in the FIFO buffer section 30 in units of a specified number of bytes, it is possible to put the number of access times of each frame as information equivalent to the data size of the quantization data of each frame. Also, by reading from the FIFO buffer section 30 in units of a specified number of bytes, it is possible to put the number of access times of each frame as information equivalent to the data size of the quantization data of each frame.

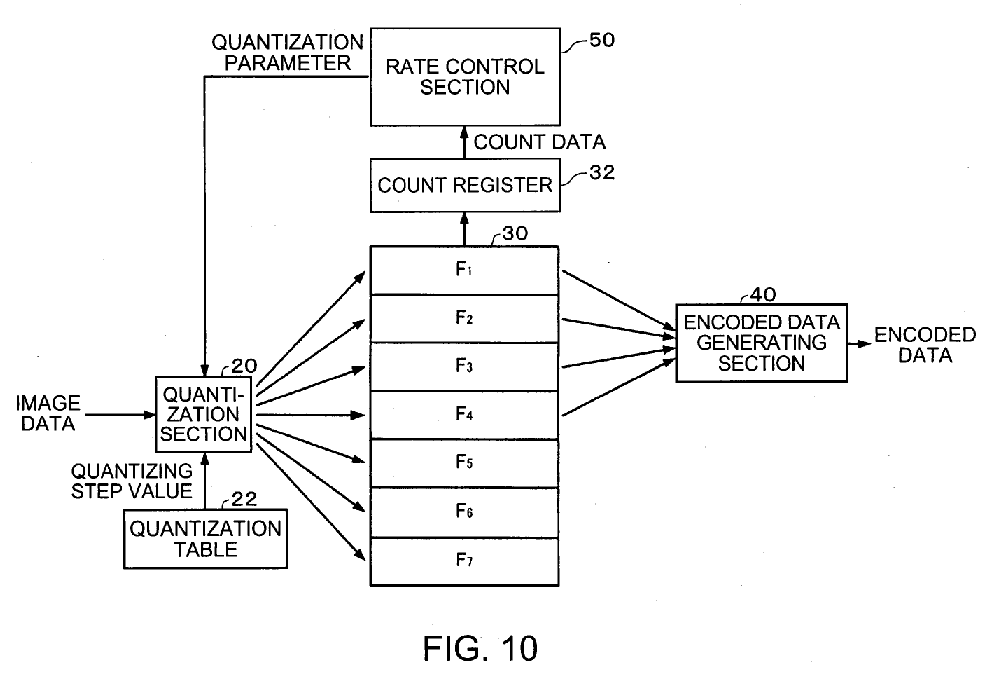

In FIG. 10, there is shown an explanatory diagram of the rate control method in the present embodiment. However, like parts of the image data compression apparatus 10 shown in FIG. 8 are given like reference numerals, omitting explanation as necessary. Now, in FIG. 10, it is understood that the FIFO buffer parts 30 is able to store the quantization data of seven frame portions.

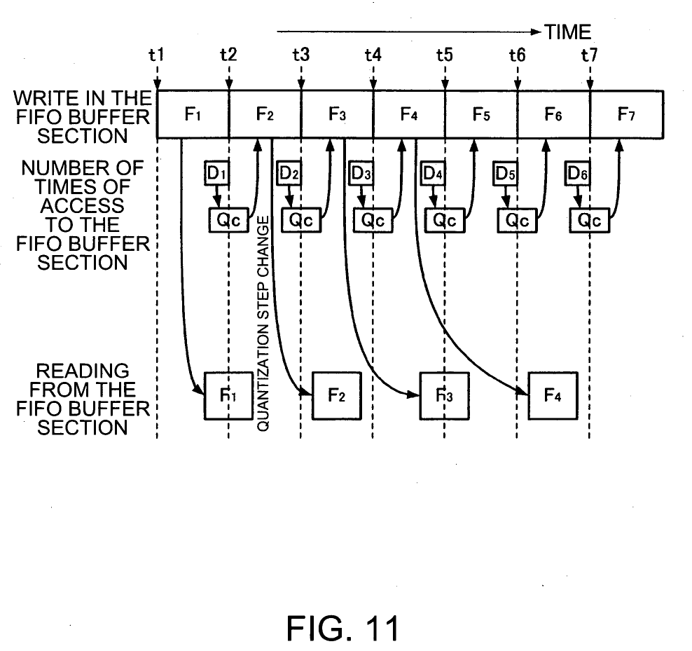

In FIG. 11, there is a schematic diagram of motion timing of the rate control method shown in FIG. 10.

The quantization section 20 quantizes data in frame units. For example, there is provided a quantization table 22 in which quantization step values shown in FIG. 4 are set. And the quantization section 20 quantizes image data in frame units based on a quantization parameter from the quantization step value set in the quantization table 20 and the rate control section 50. More specifically, the quantization step is changed by performing quantization as the quantization section 20 uses a product of the quantization parameter multiplied by the quantization step value with the quantization parameter as a coefficient of the quantization step value.

The quantization section 20 quantizes image data in frame units at times t1, t2, . . . , writing quantization data in order of a 1st frame F₁, a 2nd frame F₂, . . . in the FIFO buffer section 30. Count data held by a count register 32 in each frame is initialized at each frame and incremented and updated whenever writing in the FIFO buffer section 30 generates. By doing so, upon completion of writing in the quantization data of each frame, in the count register 32, there is set up count data corresponding to a number of times of writing in the FIFO buffer section 30.

On the other hand, the encoded data generating section 40 reads quantization data from the FIFO buffer section 30 in frame units asynchronously with a write timing of quantization data in the FIFO buffer section 30, and performs encode processing.

The rate control section 50 changes the quantization step of the quantization section 20 and reflects it in the next frame, based on count data upon completion of writing in the quantization data of each frame, independently from processing of the encoded data generating section 40. By doing so, at a frame next to the frame which completed writing the quantization data, a size of the quantization data quantized in the quantization section 20 changes, and as a result of this, a size of encoded data generated by the encoded data generating section 40 also changes.

In FIG. 11, the encoded data generating section 40 reads successively quantization data from the FIFO buffer section to the first to the 4th frame F₁ to F₄, respectively, generates and outputs encoded data of each frame.

In the count register 32, there is held count data D₁ upon completion of writing the quantization data of the 1st frame F₁ in the FIFO buffer section 30. The count data D₁ is data corresponding to the number of times of writing the quantization data of the 1st frame F₁ in the FIFO buffer section 30. The count data D₁ is made to correspond to the data size of the quantization data of the 1st frame F₁. This count data is initialized at the starting point of the 2nd frame F₂, and upon completion of writing the quantization data of the 2nd frame F₂ in the FIFO buffer section 30, the count data D₂ is held. The count data D₂ is data corresponding to the number of times of writing the quantization data of the 2nd frame F₂ in the FIFO buffer section 30.

The rate control section 50 reads the count data whenever wiring in the FIFO buffer section 20 is completed and changes the quantization step of the next frame. In FIG. 11, upon completing writing the quantization data of the 1st frame F₁, the rate control section 50 reads the count data D₁ and obtains the predictive data size from the count data D₁. And as explained in FIG. 6 and FIG. 7, the rate control section 50 calculates an encode amount to be used in encoding the 2nd frame F₂ by using this predictive data size and obtains the quantization parameter Q_{c}. As a result, the quantization section 20 quantizes the quantization of image data of the 2nd frame F₂ by using a product of the quantization parameter Q_{c} obtained based on the predictive data size of the encoded data of the 1st frame F₁ multiplied by the quantization step value of the quantization table 22. The result of this quantization is written in the FIFO buffer section 30. In this manner, through the use of the predictive data size preceding by one frame per frame, the encoded data can be generated at a desired rate.

3.1 Calculation Processing of the Quantization Parameter Q_{c}

Next, calculation processing of the quantization parameter Q_{c} to be carried out in the rate control section 50 will be described in detail.

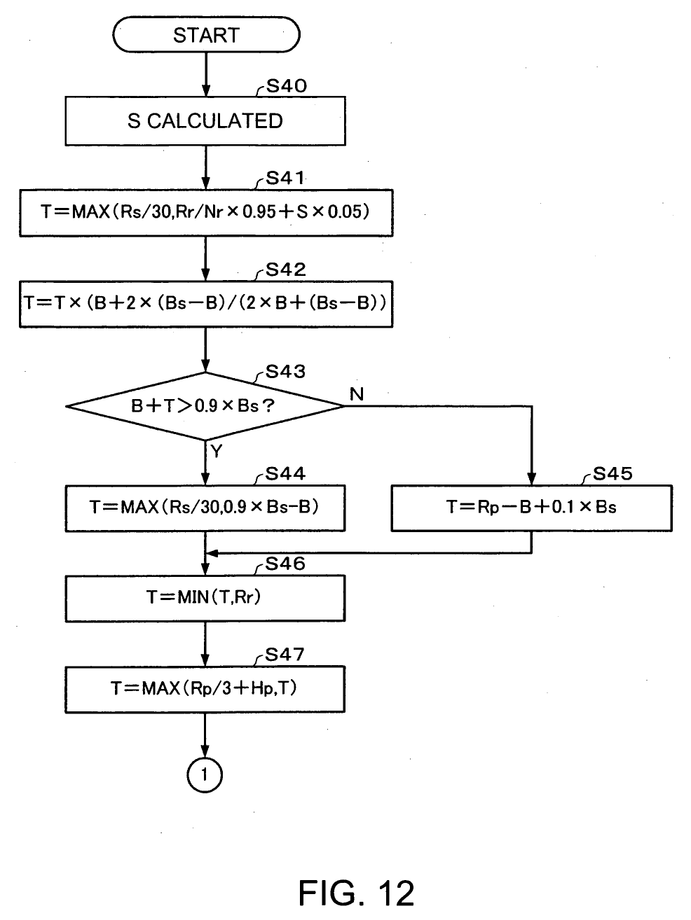

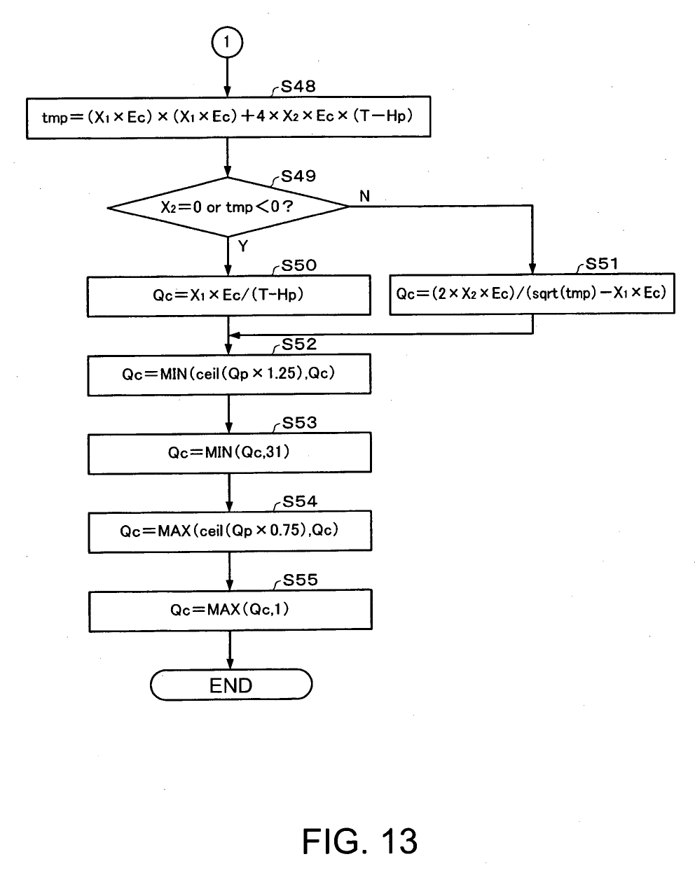

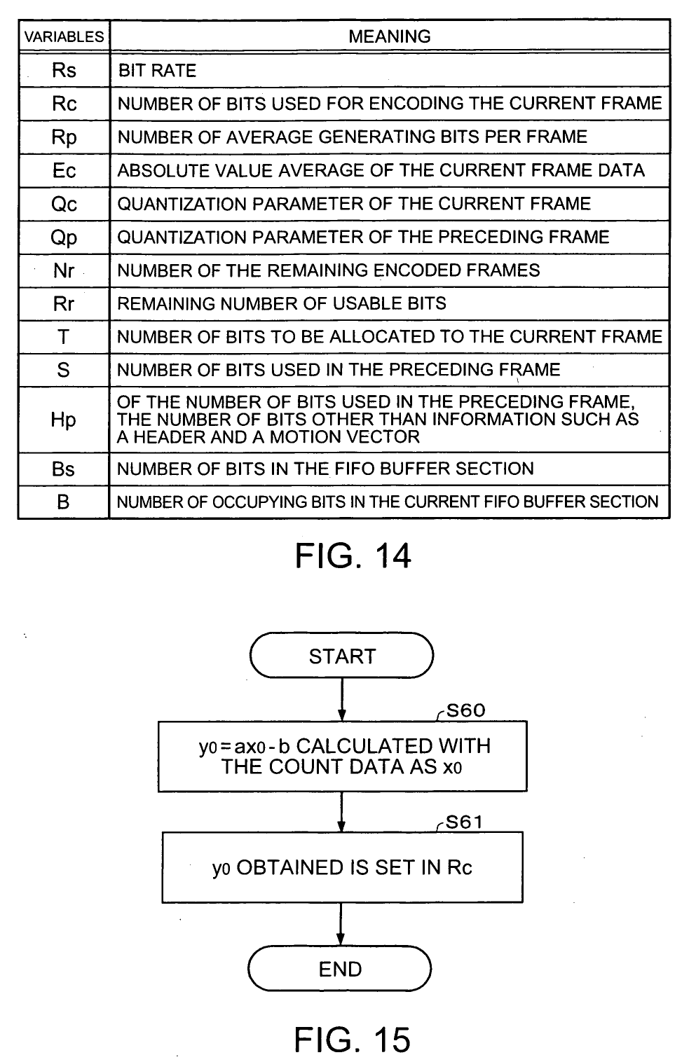

In FIG. 12 and FIG. 13, there is shown an example of a flow of calculation processing of the quantization parameter Q_{c}. Now, referring to an explanatory diagram of variables used in calculation processing shown in FIG. 14, the flows shown in FIG. 12 and FIG. 13 will be described. The flows shown in FIG. 12 and FIG. 13 are carried out per frame.

First, a bit number S used in the previous frame is calculated (step S40). Now, for the variable S, a value of a bit number (bit number used for encoding the current frame) R_{c} is set.

In FIG. 15, an example of a flow of calculation processing of the bit number R_{c} used in encoding is shown. Now, count data read from the count register 32 as information equivalent to the data size of the quantization data preceding the current frame by one frame is set as x₀, and it is substituted into equation (1) to obtain the predictive data size y₀ of the encoded data of the current frame (step S60).

And the predictive data size y₀ obtained in step S60 is set as a value of the bit number R_{c} (step S61).

The value of the bit number R_{c} obtained in this manner is set as the variable S in the next frame.

Returning to FIG. 12, description is continued. When the value of the variable S is obtained, a bit number T to be allocated to the current frame is obtained (step S41). In the step S41, an average allocation bit number (Rᵣ/Nᵣ) is obtained from a remaining usable bit number R₁ and a number of pieces of remaining encoding frames Nᵣ, and with a ratio of that value and the allocated bit number S of the preceding frame, a bit number T to be allocated to the current frame is obtained. In step S41, for example, it is 0.95:0.05. And it is arranged such that the bit number T to be allocated to the current frame will not fall below a value of Rₛ/30 which is the lower limit.

Next, from a ratio of an occupying bit number B of the current FIFO buffer section 30 and a bit number Bₛ of the FIFO buffer section, the bit number T to be allocated to the current frame is adjusted (step S42). As a result, if the occupying bit number B of the current FIFO buffer section 30 is less than half the bit number Bₛ of the FIFO buffer section 30, a value of the variable T is made larger, while, if it is large, the value of the variable T is made small.

And it is determined whether a value obtained by adding the occupying bit number B of the current FIFO buffer section 30 to the variable T exceeds 90% of the bit number Bₛ of the FIFO buffer section 30 (step S43). If the added value is determined to exceed 90% of the value of the variable Bₛ (step S43:Y), the value of the variable T is clipped to a value obtained by subtracting the value of the variable B from the 90% of the bit number Bₛ of the FIFO buffer section 30 (step S44). Namely, it is set such that the value obtained by adding the occupying bit number B of the current FIFO buffer section 30 to the variable T may not exceed the 90% of the value of the variable Bₛ of the FIFO buffer section 30. Also, in the same way as step S41, it is set such that the value of the variable T may not fall below the value of Ra/30 which is the lower limit.

On the other hand, in step S43, if it is determined that the added value does not exceed 90% of the value of the variable Bₛ (step S43:N), the value of the variable T is set to a value obtained by subtracting the value of the variable B from an average generating bit number Rp per frame and adding 10% of the value of the variable T (step S45). Namely, it is set such that the value obtained by subtracting the average generating bit number Rp per frame from the added value of the variable Bs and the variable T may not fall below the 10% of the bit number Bs of the FIFO buffer section 30.

Following step S44 or step S45, the value of the variable T is set so that it may not exceed a remaining usable bit number Rr (step S46). Next, the value of the variable T is adjusted so that the value of the variable T may not fluctuate to extremes (step S47).

Next, to obtain a value of the quantization parameter Qc, the model equations shown in FIG. 6 are solved as a quadratic equation of the variable Qc. For this purpose, as shown in FIG. 13, first, a value of variable tmp is obtained (step S48)

At this point, if model parameter X2 is 0, or if a value of the variable tmp is a minus value (step S49:Y), the quantization parameter Qc is obtained from the model equation which will become a linear equation.(step S50). At this point, since the variable R becomes a value obtained by subtracting a bit number Hp which is other than information such as a header and the like out of the bit numbers used in the preceding frame from the bit number T allocated to the current frame, it is obtained from Qc=x, xEc/(T--Hp). Also, a value of a variable Ec is, as shown in FIG. 6, an average of absolute values of pixels of frames.

In step S49, if the model parameter X is not 0 and a value of the variable tmp is more than 0 (step S49:N), a solution of a quadratic equation derived from the model equations shown in FIG. 6 is a value of the quantization parameter Qc (step S51).

Following step S50 or step S51, it is processed such that the value of the quantization parameter Qc is set so that its difference with the quantization parameter Qp of the preceding frame falls within 25% and that the value of the quantization parameter Qc becomes a value of 1-31 (step S52, step S53, step S54, and step S55). In step S52 and step S54, ceil (x) means rounding up the x value to the positive direction to make it an integer.

By supplying the quantization parameter Qc thus obtained to the quantization section 20, the quantization step of the quantization section 20 is made to change.

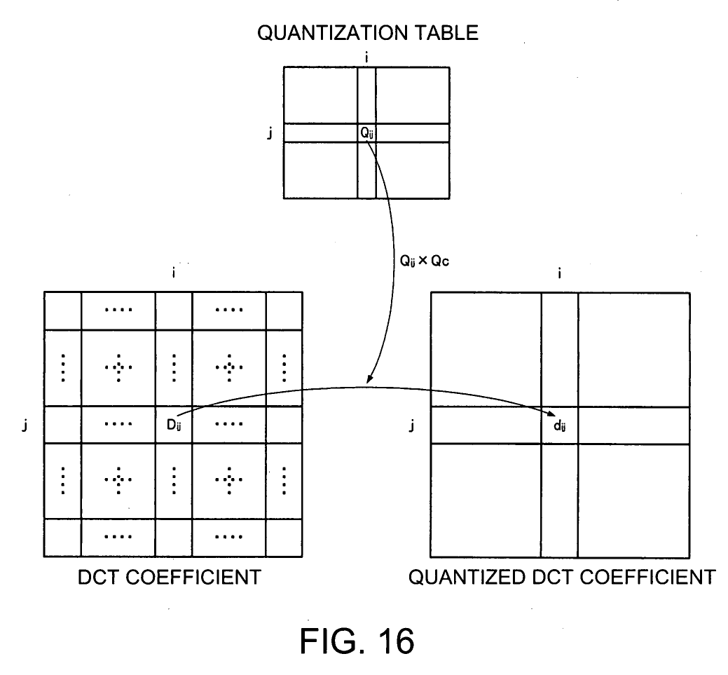

Namely, for example, as shown in FIG. 16, a DCT coefficient Dᵢⱼ of the image data which can be expressed by a DCT coefficient is divided by a product of a quantization step value Qᵢⱼ at a position corresponding to the quantization table multiplied by the quantization parameter Qc to obtain the quantized DCT coefficient dᵢⱼ. As a result, it is possible to increase or decrease the zero data of the quantized DCT coefficient.

3.2 Configuration Example

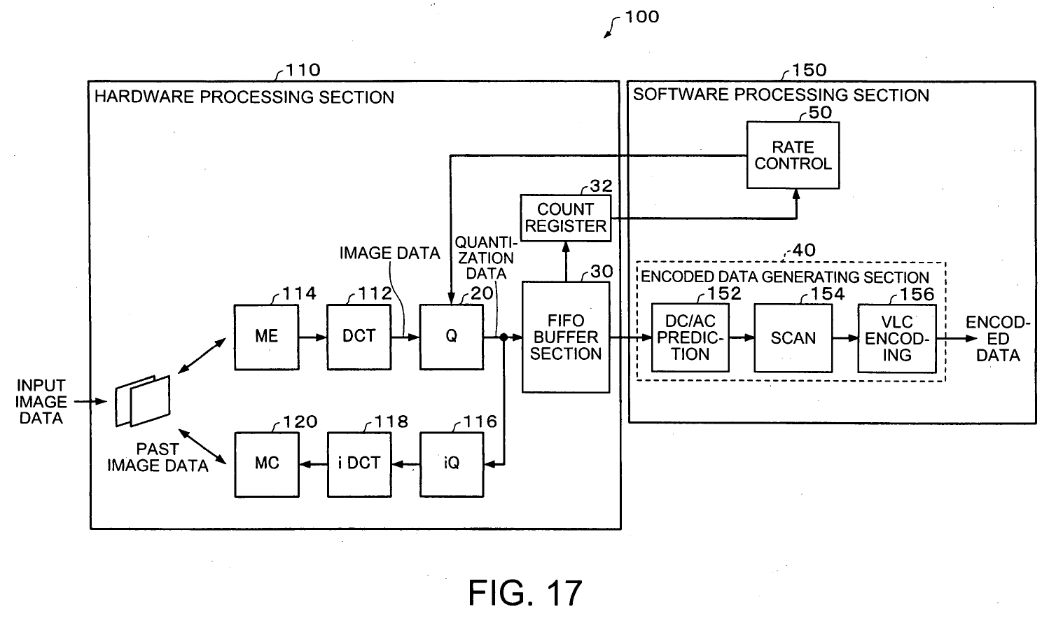

In FIG. 17, there is shown a detailed functional block diagram of the image data compression apparatus of the present embodiment. However, like parts of the image data compression apparatus 10 shown in FIG. 8 are given like reference numerals, omitting explanation as necessary.

An image data compression apparatus 100 shown in FIG. 17 carries out image data compression processing of a dynamic image in compliance with MPEG-4. The image data compression apparatus 100 shown comprises a hardware processing section 110 and a software processing section 150.

The hardware processing section 110 processes image data of a dynamic image by means of hardware. This hardware processing section 110 includes the FIFO buffer section 30 and the count register 32. The hardware processing section 110 does not use any software, but is realized through hardware such as ASIC and exclusive circuits.

The software processing section 150 subjects quantization data read from the FIFO buffer section to encode processing with software and generates encoded data. This software processing section 150 includes the encoded data generating section 40 and the rate control section 50. The software processing section 150 is a processing section whose function is realized by software (firmware), and its function is realized by a CPU and the like (hardware) that read the software (firmware).

To be more specific, the hardware processing section 110 includes a discrete cosine transform (DCT) section 112, a motion detection section 114, an inverse quantization section 116, an inverse DCT section, and a motion compensation section 120. The DCT section 112 performs processing of step S2 shown in FIG. 1A. The motion detection section 114 performs processing of step S1 shown in FIG. 1A. The inverse quantization section 116 performs processing of step S4 shown in FIG. 1A. The inverse DCT section 118 performs processing of step S5 shown in FIG. 1A. The motion compensation section 120 performs processing of step S6 shown in FIG. 1A.

Namely, the hardware processing section 110 outputs as motion vector information a differential between input image data of the current frame and past image data which is preceding the current frame by one frame, and carries out discrete cosine transform with respect to the motion vector information and outputs it as image data to the quantization section. Further, with respect to this quantization data, the above-mentioned past image data is generated based on the inverse quantization data which is obtained by carrying out inverse quantization in the above-mentioned quantization step.

Now, it is not necessary for the hardware processing section 150 to be configured including every section, whereas a configuration with an omission of at least one of the above-mentioned each section omitted may be acceptable.

Also, the encoded data generating section 40 of the software processing section includes a DC/AC prediction section 152, a scan section 154, and a VLC encoding section 156. The DC/AC predictive section 152 performs processing of step S7 shown in FIG. 1A. The scan section 154 performs processing of step S8 shown in FIG. 1A. The VLC encoding section 156 performs processing of step S9 shown in FIG. 1A.

Now, it is not necessary for the software processing section 150 to configure by including all of each of these sections, but a configuration omitting at least one of the above-mentioned each section may be acceptable. For example, the software processing section 150 may be such that the quantization data read from the FIFO buffer section is subjected to encoding in terms of variable-length encode Also, the software processing section 150 may be such that it is subjected to scan processing to permutate the quantization data read from the FIGFO buffer section 30. Furthermore, the software processing section 150 may be such that the DC component and the AC component are obtained from the quantization data read from the FIFO buffer section 30, with scan processing performed to permutate the DC component and the AC component, so that results of the scan processing may be encoded in terms of variable-length encode.

At this point, in the present embodiment, there are following reasons for subjecting steps S1-S6 of FIG. 1A to hardware processing and steps S7-S10 to software processing. First, if it is after the quantization of step S3 of FIG. 1A, as shown in FIG. 5, in each block, there is an overwhelming amount of zero data, whereas, by comparison to data (FIG. 3) prior to quantization, kinds of the information volume of data are significantly small. Furthermore, since a load of calculation itself of steps S7-S120 is small, even if the steps S7-S10 of FIG. 1A are processed by software, its processing load becomes small. Conversely, the quantization of step S3 of FIG. 1A, the DCT of step S2, the inverse DCT of step S5 and the like have large information volumes with complicated calculations, such as to make too heavy a load for the software to process. While these quantization, DCT, inverse DCT, motion estimation and the like entail processing with heavy loads, standards are stipulated so that there is little need of a change to be made. Further, since repeated processing abounds in the steps S1-S6, they are suited to hardware processing. Furthermore, as mentioned above, because of a small amount of data after quantization processed in the hardware processing section 110, there is a small amount of data to be transferred from the hardware processing section 110 to the software processing section 150, thus lightening a load on data transfer control.

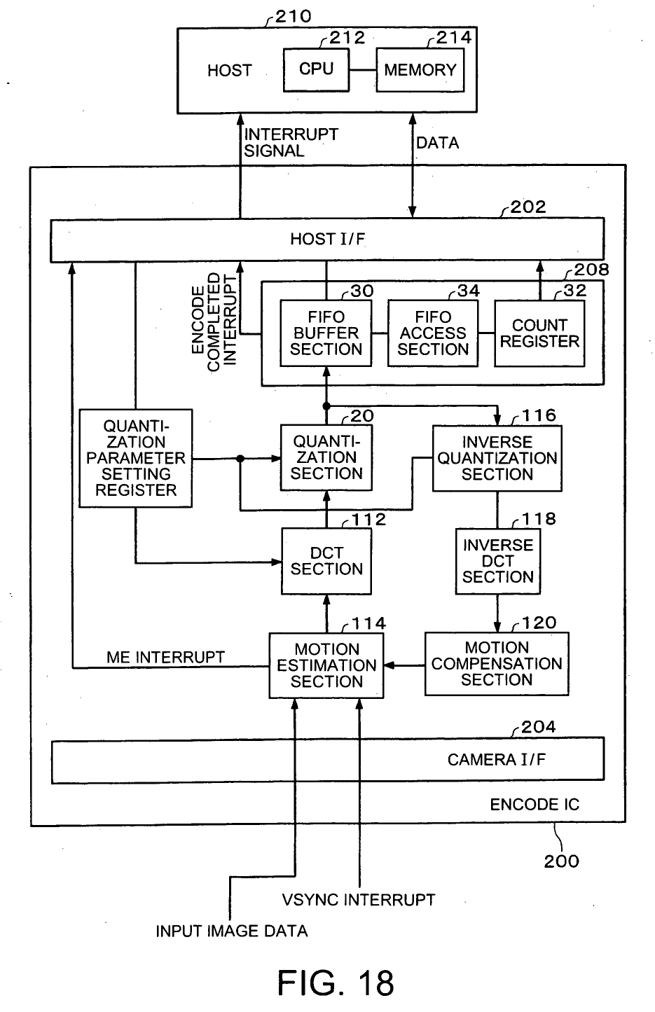

In FIG. 18, there is shown an example of hardware configuration of the image data compression apparatus 100. Here is the image data compression apparatus 100 being integrated and mounted on a semiconductor apparatus as encode IC (integrated circuit) (encoder in a broad sense). Also, function of the software processing section 150 shown in FIG. 17 is realized by the host 210. It should be noted that in FIG. 18, like parts of the hardware processing section 110 shown in FIG. 17 are given like reference numerals, omitting explanation as necessary.

The host 210 includes a CPU 212 and a memory 214. The memory 214 is stored with a program to realize functions of the encoded data generating section 40 and the rate control section 50. The CPU 212 reads the program stored in the memory 214 and performs processing based on the program, thus realizing the function of the encoded data generating section 40 and the rate control section 50.

At this point, an encode IC200 performs encoding of image data of dynamic image obtained by picking up an image in an un-illustrated camera module (image pickup section in a broad sense) in compliance with the MPEG-4 standards and generates encoded data at a fixed rate. Consequently, the encode IC200 has, in addition to a circuit to realize a function of each section of the hardware processing 110 shown in FIG. 17, a host interface (I/F) 202, a camera I/F (image input interface in a broad sense) 204, and a quantization parameter setting register 206.

The encode IC200 includes an FIFO section 208. The FIFO section 208 includes the FIFO buffer section 30, the count register 32, and the FIFO access section 34. The FIFO access section 34 performs control of writing quantization data from the quantization section 20 in the FIFO buffer section 30, while, at the same time, performing processing to update count data held in the count register 32. More specifically, the FIFO access section 34 performs control of writing the quantization data in the FIFO buffer section 30 in units of a specified number of bytes. Also, the FIFO access section 34 increments the count data to perform processing of updating the count register 32, whenever performing control of writing in the FIFO buffer section 30. And in the count register 32, there is held information on the number of times of writing (access frequency) corresponding to the data size of the quantization data at the point in time when the quantization data of a one frame portion is written in the FIFO buffer section 30.

The encode IC 200 and the host 210 realize a function of an image data compression apparatus shown in FIG. 8 and FIG. 17 through exchanging an interrupt signal and data.

A host I/F202 performs interface processing with the host 210. More specifically, the host I/F202 controls generating an interrupt signal from the encode IC200 to the host 210 and transmitting/receiving data between the host 210 and the encode IC200. The host IF202 is connected to the FIFO buffer section 39 and the current register 32.

A camera I/F204 performs interface processing for inputting input image data of a dynamic image from an un-illustrated camera module. The camera I/F204 is connected to a motion estimation section 114.

The un-illustrated camera module supplies image data of a dynamic image obtained from image pickup, as input image data, to the encode IC200. At this time, the camera module also supplies a VSYNC signal (vertical synchronizing signal) that specifies frame delimiting of input image data to the encode IC200. In the encode IC200, the camera I/F204 accepts the VSYNC signal from the camera module as a VSYNC interrupt. This enables the encode IC200 to start encoding.

The motion estimation section 114 does not perform motion estimation in regard to input image data first taken in after encoding started, but perform motion estimation after input image of a next frame is taken in. Since the details of motion estimation is as described above, explanation of motion such as the inverse quantization section 116 will be omitted here. In this manner, at a stage where motion estimation is conducted, quantization data of at least a one frame portion is written in the buffer section 30. Upon completion of motion estimation of the motion estimation section 114, the motion estimation section notifies a motion estimation completion interrupt (ME interrupt) to the host 210 via the host I/F202.

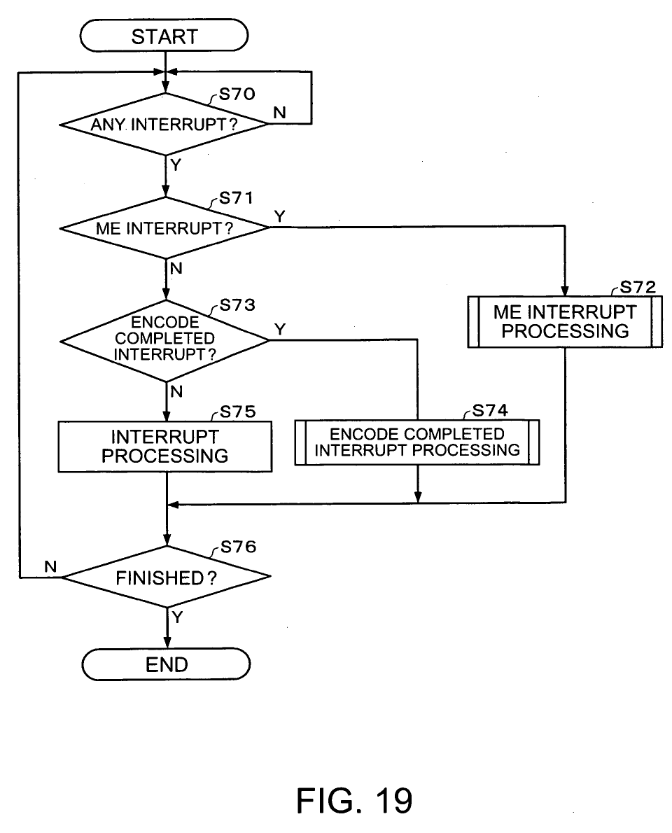

In FIG. 19, there is shown an example of a flow of interrupt receive processing carried out by the host 210. In the memory 240, there is stored a program to realize processing shown in FIG. 19. The CPU 212 reads this program and realizes processing shown in FIG. 19.

First, the CPU 212 monitors an interrupt input (step S70:N). And when the CPU 212 detects the interrupt (step S70:Y), it determines whether that interrupt is an ME interrupt or not (step S71).

When the CPU 212 determines that it is the ME interrupt (step S71:Y), ME interrupt processing to be explained later is executed (step S72). Since image data is inputted per frame, ME interrupt processing is executed per frame.

When the CPU 212 determines that it is not the ME interrupt (step S71:N), it determines whether it is an encode completion interrupt to be explained later or not(step S73). Further, when the CPU 212 determines that it is an encode completion interrupt (step S73:Y), encode completion interrupt processing is executed (step S74)

In step S73, when the CPU 212 determines that it is not an encode completion interrupt (step S73:N), specified interrupt processing is executed (step S75).

Following step S72, step S74 or step S75, when it is not completion (step S76:N, a return is made to step S70, and when it is completion (step S76:Y), a series of processing ends (END).

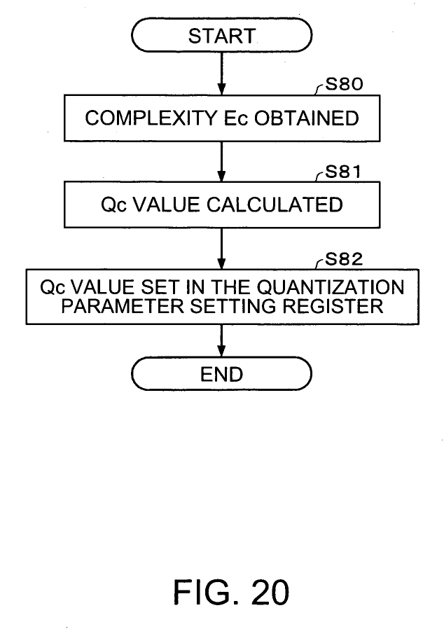

In FIG. 20, there is shown an example of a flow of ME interrupt processing. In a memory 214, there is stored a program realizing the processing as shown in FIG. 20. The CPU 212 reads this program and realizes the processing shown in FIG. 20.

This ME interrupt processing is carried out in step S72 of FIG. 19.

When an ME interrupt is estimated, the CPU 212 reads complexity Ec generated at the ME section 114 through the host I/F202 (step S80). This complexity Ec is generated by the ME section 114 according to the equations shown in FIG. 6.

Subsequently, the CPU 212 obtains a quantization parameter Qc (step S81). To be more specific, the CPU 212 obtains the value of the quantization parameter Qc as explained in FIG. 12-FIG. 15.

Next, the CPU 212 sets the value of the quantization parameter Qc obtained in step S81 through the host I/F 202 in a quantization parameter setting register 206 (step S82) and completes a series of processing.

Back to FIG. 18, description is continued. The encode IC200 begins processing of the DCT section 112, as a result of the quantization parameter Qc's value being set in the quantization parameter setting register 206. And as mentioned above, in the quantization section 20, DCT coefficient (image data in a broad sense) generated by the DCT section 112 is quantized by using the quantization parameter set in the quantization parameter setting register 206 and the quantization step value of the un-illustrated quantization table. Quantization data which is its result is written in the FIFO buffer section 30.

At this time, the FIFO access section 34 increments the count data and updates the count data whenever writing in the FIFO buffer section 30 generates. And, upon completion of writing the quantization data in the FIFO buffer section 30, the FIFO section 208 notifies to the host I/F 210 via the host I/F 202 by means of an encode completion interrupt indicating that encode processing of one frame has been completed

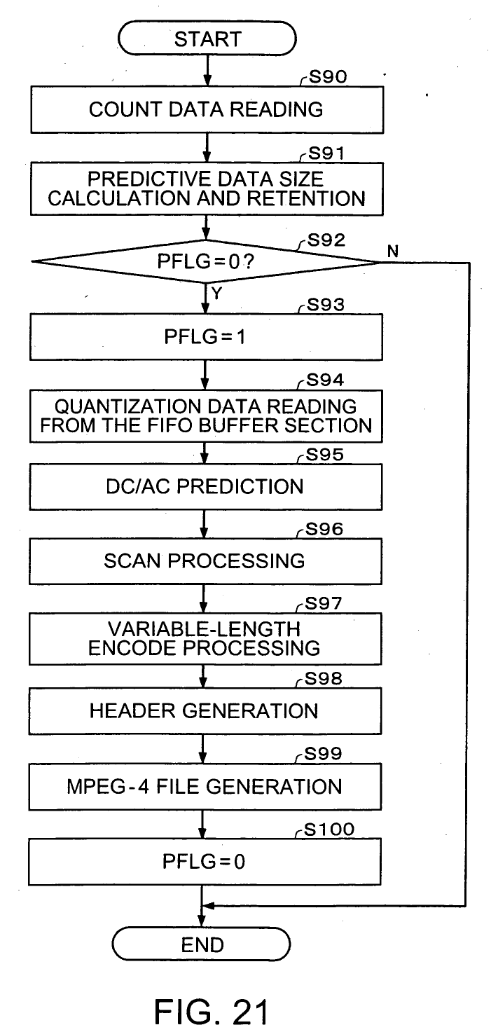

In FIG. 21, an example of a flow of encode completion interrupt processing is shown. In the memory 214, there is stored a program to realize processing shown in FIG. 21. The CPU 212 reads this program and realizes the processing shown in FIG. 21.

Encode completion interrupt processing is carried out by step S74 shown in FIG. 129.

When the CPU detects an encode completion interrupt, it reads count data held in the count register 32 (step S90). Then, as shown in FIG. 15, with count data read from step S90 as x₀, predictive data size y₀ is obtained and saved in a specified temporary area (step S91).

Next, whether a processing execution flag PFLO is 0 or not is determined (step S92). The processing execution flag PFLO is a flag to show whether generating processing of encoded data (processing of steps S7-S9 of FIG. 1A) is being executed or not. If the processing execution flag PFLO is determined to be not 0 (step S92:N), processing of the encoded data generating section 40 is determined to be being executed, a series of processing ends (END).

In step S92, if the processing execution flag PFLO is determined to be 0 (step S92:Y), generating processing of encoded data is executed.

In this generating processing of encoded data, first, the processing execution flag PFLO is set at 1 (step S93). Even in a case where an encode completion interrupt occurs, this makes it possible to let execution of generating processing of encoded data of the next frame wait.

And from the FIFO buffer section 30, quantization data of one frame is read in units of a specified number of bytes (step S94).

And the CPU 212 performs in macro block units DC/AC predictive processing (step S95), scan processing (step S96), and variable-length encode processing (step S97) and generates encoded data.

Next, the CPU 212 adds a macro block header to the encoded data generated in the step S97. The encoded data obtained in this manner is carried out for one VOP (Video Object Plane) portion, generates a GOV header and a VOP header based on the quantization parameter already obtained (step S98), and, upon completing encoding a portion of specified number of frames, outputs it as an MPEG-4 file (step S99).

And, following the step S99, the processing execution flag PFLO is set at 0 (step S100) and completes a series of processing (END).

As mentioned above, the hardware processing section 110 and the software processing section 150 share in carrying out compression processing of image data.

To perform the rate control of the encode IC200 as mentioned above, in the present embodiment, the host 210 memorizes a following processing formula to perform linear transformation and performs the rate control as mentioned above.

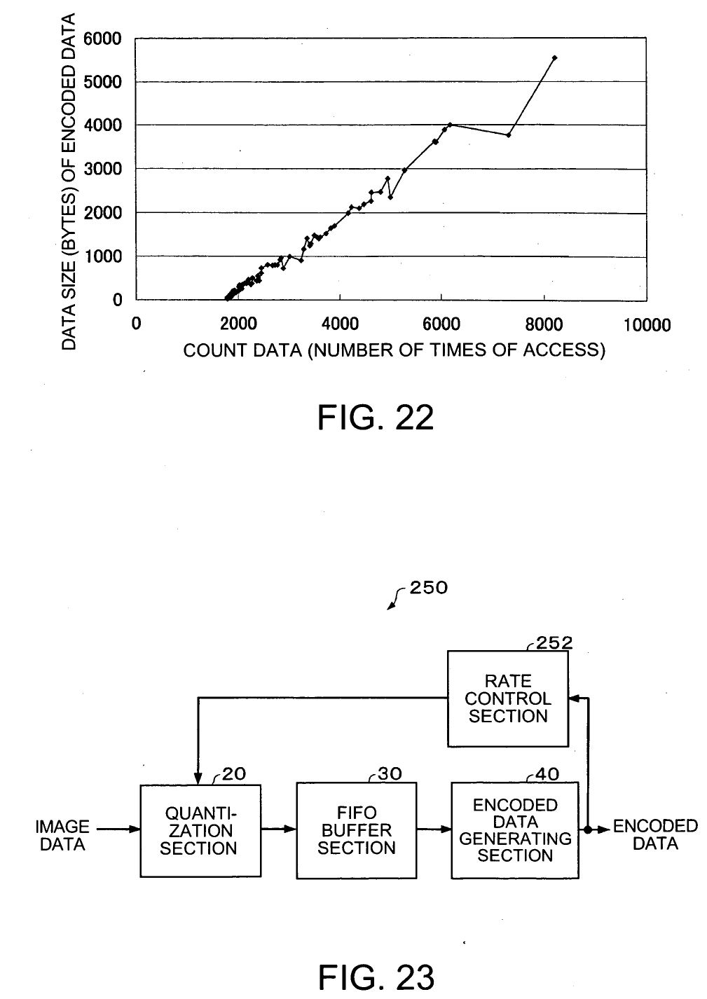

In FIG. 22, a relationship diagram between the count data and the predictive data size is shown.

Shown here are a bit rate of 64 kbps, a frame rate of 15 fps, an image size QCIF (176×144 pixels), with the axis of abscissa of count data showing a number of times of accessing the FIFO buffer section 30 and the axis of ordinate of data sizes (byte number) of encoded data after VLC encoding.

In this manner, it is apparent that the relationship of the count data and the data size of the encoded data is linear.

Based on measured values shown in FIG. 22, in equation (1), for example, by making a as ⅘, h as (13.5625×99×8), the linear relationship can be expressed in approximation. Hence, using this linear transformation, it is possible to obtain the predictive data size easily.

3.3 Effects

Next, in contrast to a comparative example of the present embodiment, effects of the present embodiment will be described. When making the hardware and the software share in regard to the above-mentioned image data compression processing, the FIFO buffer section 30 absorbing processing capacity of both is needed. In such a case, as a comparison example to realize the above-mentioned rate control method, differently from the present embodiment, quantization step may be considered based on the data size of encoded data of a past plurality of frames.

In FIG. 23, there is shown a block diagram outlining configuration of an image data compression apparatus. In an image data compression apparatus 250 of the comparison example, like parts of the image data compression apparatus 10 shown in FIG. 8 are given like reference numerals, omitting explanation as necessary.

In contrast to the image data compression apparatus of the present embodiment, in the image data compression apparatus 250 in the comparison example, a rate control section 252 is designed to change the quantization step of the quantization section 20 based on an average data size of encoded data for an N frame portion (N being an integer of more than 2).

Namely, in the comparison example, the rate control section 252 obtains an average data size by averaging data sizes of encoded data of each frame of the past N frame portion from the frames of image data quantized in the quantization section 20 and changes the quantization step based on the average data size. For example, when image data quantized in the quantization section 20 is the L-th (L being a positive integer) frame, the rate control 252 changes the quantization step based on the average data size which is obtained by averaging data sizes of encoded data from the (L−P)-th (L>P, P a positive integer) frame to the (L−P−N+1)-th (L−P>N−1) of the N frame portion more past than the L frame.

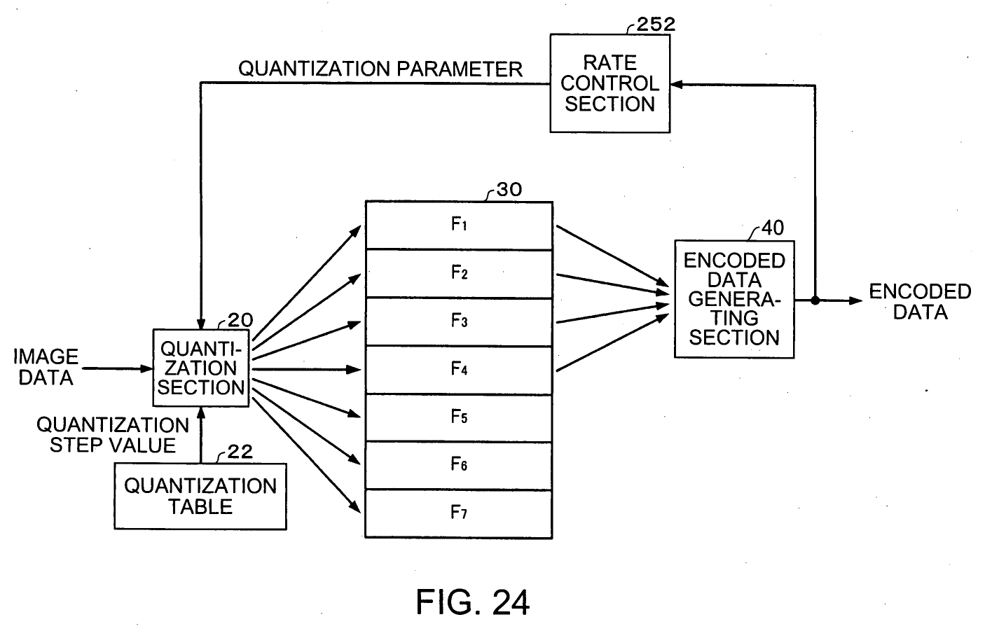

In FIG. 24, there is shown an explanatory diagram of the rate control method in the comparison example. However, like parts of the image data compression apparatus 250 shown in FIG. 23 are given like reference numerals, omitting explanation as necessary.

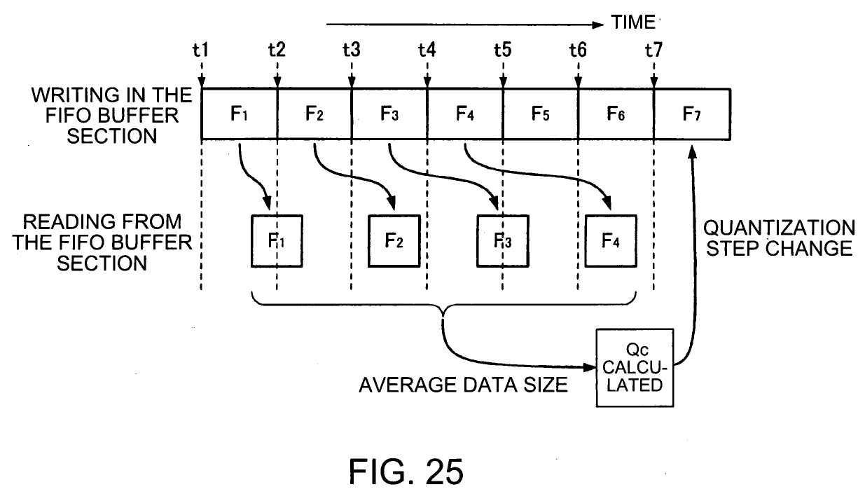

In FIG. 25, there is shown a schematic diagram of motion timing of the rate control method shown in FIG. 24.

The quantization section 20 quantizes image data in frame units at times t1, t2, . . . and writes the quantization data in order of the 1st frame F₁, the 2nd frame F₂, . . . in the FIFO buffer section 30. The encoded data generating section 40 reads quantization data in frame units from the FIFO buffer section 30 asynchronously from a write timing of the quantization data in the FFIFO buffer section 30, and performs encode processing.

And the rate control section 252 changes the quantizing step of the quantization section 20 based on an average data size obtained by averaging data sizes of encoded data of each frame of the more past, for example, (N=4) frame portion than the frame (current frame) of image data quantized in the quantization section 20. By this means, the size of the quantization data quantized by the quantization section 20 changes, and as a consequence of this, the size of encoded data generated by the encoded data generating section 40 changes.

In FIG. 25, the encoded data generating section 40 reads from the FIFO buffer section 30 the quantization data in order of the 1st frame F₁ to the 2nd frame F₄, generates and outputs respective encoded data of respective frames. At this time, the quantization section 20 performs quantization of image data of the 7th frame F₇.

The rate control section 252 memorizes a size of encoded data of each frame of the first to the 4th frame F₁ to F₄, and obtains the average value of the sizes of the encoded data of each frame in the first to the 4th frame F₁ to F₄. Further, as explained in FIG. 6 and FIG. 7, the rate control section 252 calculates an encode amount used for encoding the 7th frame F₇ by using this average data size, and obtains the quantization parameter Qc. As a result, the quantization section 20 quantizes image data of the 7th frame F₇ by using a product of the quantization parameter Qc, which is obtained based on the average value of data sizes of the encoded data from the first to the 7th frame F₁ t F₇, multiplied by the quantization step value of the quantization table 22. A result of this quantization is written in the FIFO buffer section 30. In this manner, encoded data can be generated at a desired rate.

Now, a comparison will be made between the comparison example and the present embodiment regarding changes in empty capacity of a virtual buffer verifier called VBV (Video Buffering Verifier). The VBV buffer can be described as a virtual decoder conceptually connected to an output of the encoded data generating section 40, and the encoded data generating section 40 is such that encoded data is generated for the VBV buffer not to overflow or underflow.

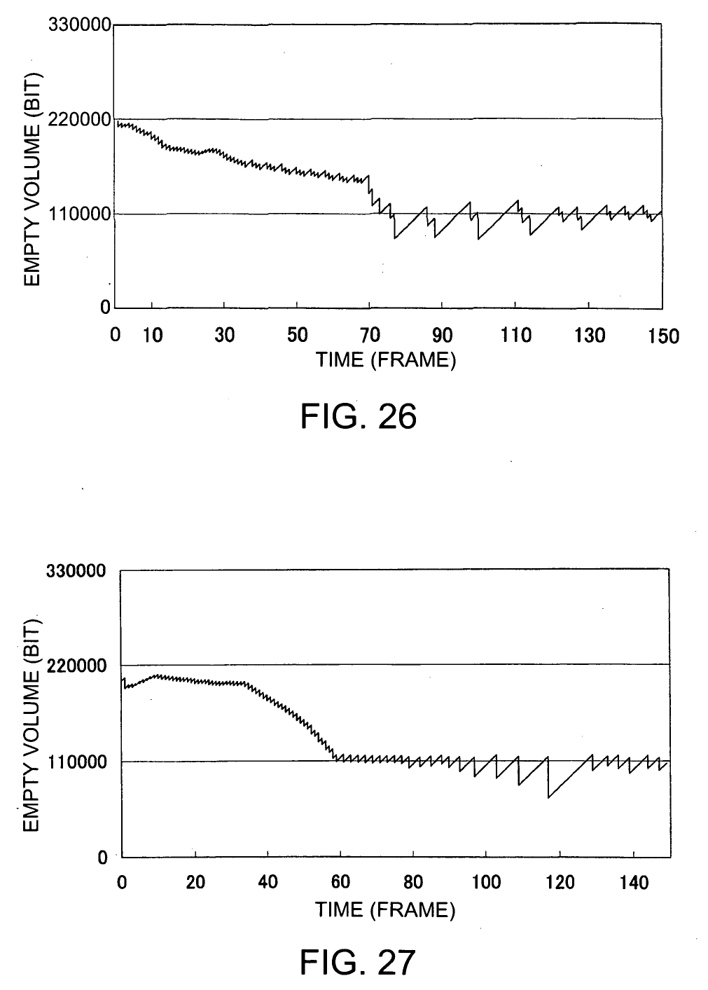

In FIG. 26, there is shown a simulation result which indicates an example of changes in the empty capacity of the VBV buffer provided in the image data compression apparatus 250 in the comparison example.

In FIG. 27, there is shown a simulation result which indicates an example of changes in the empty capacity of the VBV buffer provided in the image data compression apparatus 10 in the present embodiment.

In FIG. 26 and FIG. 27, the axis of abscissa shows the number of frames and the axis of ordinate shows a number of bits of the empty capacity of the VBV buffer.

To generate encoded data so that the VBV buffer may not overflow or underflow, when the empty capacity of the VBV buffer falls below a specified threshold (approx. 220,000 bits), frame skipping to omit encode processing is executed. It shows that at a timing of decreasing empty capacity, encode processing has been carried out in that frame. Further, it shows that at a timing of increasing empty capacity, a result of encode processing is not outputted to the VBV buffer. In this manner, a fixed rate is realized by generating encoded data so as to maintain the specified empty capacity.

In FIG. 26 and FIG. 27, there are used a total number of frames of 150, a bit rate of 64 kbps, a VBV buffer size of 327680 bits, a threshold of 109,226 bits, and an average data size of encoded data of the past four frame in the comparison example. Under such conditions, in FIG. 26 and FIG. 27, there are shown simulation results where image data of dynamic images of little initial motion but gradually rapid motion is encoded.

In a comparison example shown in FIG. 26, if focus is placed in the vicinity of a threshold of 109226 bits, despite the empty capacity falling below the threshold, encode processing is carried out, indicating that accuracy of rate control realizing the fixed rate is not so high. This is because the average data size of the past 4 frame is used so that a frame reflecting the rate control result lags by 1 to two frames.

On the other hand, in the present embodiment shown in FIG. 27, the empty capacity is maintained to be approximately in the vicinity of the threshold. This means high accuracy of prediction of the predictive data size. Namely, it means that by subjecting the number of times of writing in the FIFO buffer section 30, which precedes by one frame, to linear transformation, accuracy of obtaining the predictive data size is high, and that accuracy of controlling the bit rate based on the predictive data size is high. Consequently, in contrast to the comparison example, in the present embodiment, it is apparent that there is a low possibility of generating the VBV buffer to overflow.

4. Display Controller

Function of the encode IC in the present embodiment is applicable to a display controller.

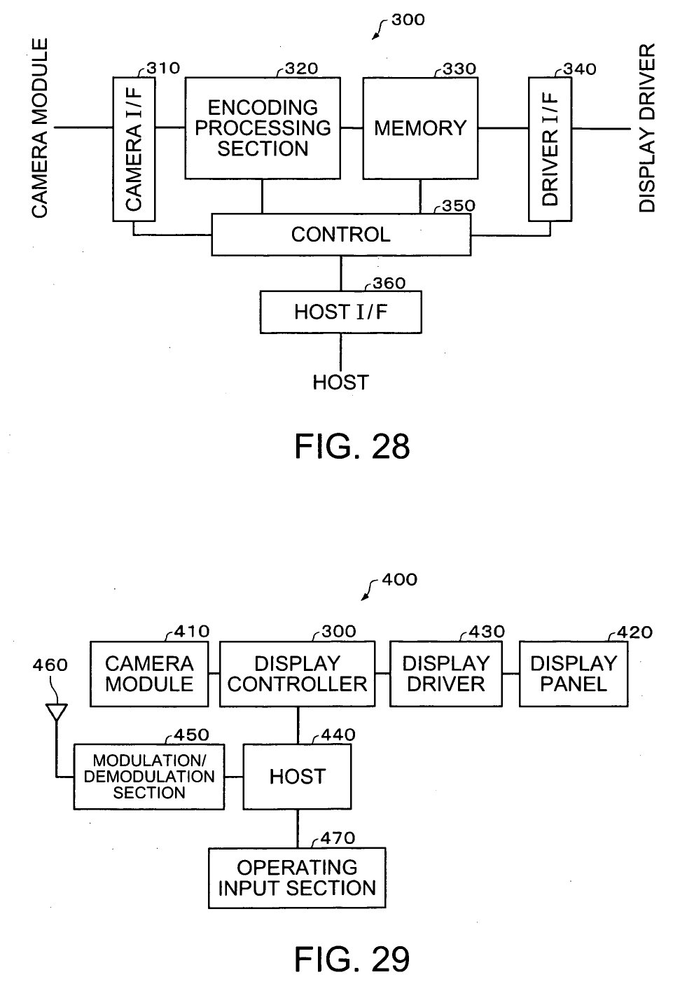

In FIG. 28, there is shown a block diagram of a configuration example of a display controller in the present embodiment.

A display controller 300 comprises a camera I/F 310, an encode processing section 320, a memory 330, a driver I/F 340, a control 350, and a host I/F 360.

The camera I/F 3190 is connected to an un-illustrated camera module. This camera module outputs input image data of a dynamic image obtained by image pickup in YUV format, while outputting a synchronizing signal (for example, a VSYNC signal) which specified one frame delimiting. The camera I/F 310 performs interface processing to receive input image data of a dynamic image generated by the camera module.

The encode processing section 320 is what remains after functions of the host I/F 202 and camera I/F 204 are omitted from the encode IC 200 of FIG. 18. Namely, the encode processing section 320 has a function of each section of the quantization section 20, the FIFO section 208, the DCT section 112, the motion estimation section 114, the inverse quantization section 116, the inverse DCT section 118, the motion compensation section 120, and the quantization parameter setting register 206.

The memory 330 memorizes encoded data which is an output of the encode processing section 32. Also, the memory 330 memorizes image data to show in the display panel, while the driver I/F 340 reads image date from the memory 330 at a specified period and supplies the image data to a display driver driving the display panel. The driver I/F 340 performs interface processing with respect to the display driver to transmit image data.

The control 350 takes charge of controlling the camera I/F 310, the encode processing section 320, the memory 330, and the driver I/F 340. The control 350 carries out, for example, through the host I/F 360, according to instructions of the un-illustrated host, receive processing of input image data from the camera module, encode processing of the input image, write processing of encoded data to the memory 330, read processing of image data for display from the memory 330, and transmit processing of the image data to the display driver.

In FIG. 29, there is shown a block diagram of a configuration example of electronic equipment to which the display controller shown in FIG. 28 applies. Here is shown a block diagram of a configuration example of a mobile phone as electronic equipment. However, like parts shown in FIG. 28 are given like reference numerals, omitting explanation as necessary.

A mobile phone 400 includes a camera module 410. The camera module 410 includes a CCD (Charge-Coupled Device) camera, supplying image data of an image picked up by the CCD camera to the display controller 300 in YUV format.

The mobile phone 400 includes a display panel 420. As the display panel 420, a liquid crystal display panel may be employed. In this case, the display panel 420 is driven by the display driver 430. The display panel 420 includes a plurality of scan lines, a plurality of data lines, and a plurality of pixels. While the display driver 430 has a function of a scan driver to select scan lines in terms of one of a plurality of scan lines or a plurality of lines, it also has a function of a data driver to supply a voltage corresponding to image data to a plurality of data lines.

The display controller 300 is connected to the display driver 430, supplying image data to the display driver 430.

The host 440 is connected to the display controller 300. The host 440 controls the display controller 300. Also, the host 440 can supply image data received through an antenna 460, after demodulating it in a modulator/demodulator 450, to the display controller 300. The display controller 300 displays, based on this image data, on the display panel 420 through the display driver 430.

Further, the host 440 has a function of the host 210 shown in FIG. 18. The host 440 encodes image data generated by the camera module 410 in the encode processing section 320 and modulate it in the modulator/ demodulator 450, then can instruct transmission to other communications devices through the antenna 460. At this time, the display controller 300 encodes image data generated in the camera module 410 and can output encoded data obtained by encoding to the host 440.

The host 440, based on operating information from an operating input section 470, performs transmit/receive processing of image data, encode processing, image pickup of the camera module 410, and display processing of the display panel.

Now, in FIG. 29, as the display panel 420, the liquid crystal display panel was explained for an example, while it is not limited to this. The display panel 420 may be electro-luminescence or plasma display equipment and is applicable to display controllers supplying image data to display drivers which drive these.

Now, while the present invention is not limited to the above-mentioned embodiment, various modifications are possible within the spirit and scope of the present invention.

Further, in regard to invention of the present invention relating to dependent claims, the constitution of the invention may be such as to omit part of the constituent features of the dependent claims. Further, the features of the invention relating to one dependent claim of the present invention may be made to depend on other independent claims.

1. An image data compression apparatus for compressing image data, comprising:
a quantization section for quantizing image data as a frame unit;
an FIFO buffer section for buffering quantization data of a plurality of frame portions quantized by the quantization section;
an encoded data generating section for writing in the FIFO section asynchronously, reading quantization data of a one frame portion from the FIFO buffer section, and generating encoded data which encoded the quantization data; and
a rate control section which changes a data size of encoded data by changing a quantization step of the quantization section, wherein:
the rate control section obtains a predictive data size of encoded data, which is preceding by one frame, from a data size of quantization data preceding a current frame by the frame, and changes the quantization step based on the predictive data size.

2. The image data compression apparatus according to claim 1, further comprising:
a count register in which count data corresponding to a number of times of accessing the FIFO buffer section is held, wherein:
the rate control section obtains the predictive data size of encoded data and changes the quantization step based on the predictive data size.

3. The image data compression apparatus according to claim 1, wherein:
the predictive data size is a data size obtained by subjecting a data size of the quantization data, which is preceding by the one frame, to linear transformation.

4. The image data compression apparatus according to claim 3, wherein:
the linear transformation is a transformation which used a coefficient corresponding to an encoding efficiency of the encoded data generating section.

5. The image data compression apparatus according to claim 4, wherein:
the linear transformation is further a transformation which performs correction of a header size portion to be added to the encoded data.

6. The image data compression apparatus according to claim 1, further comprising:
a quantization table for memorizing a quantization step value, wherein:
the rate control section obtains a quantization parameter based on the predictive data size, changing the quantization step by performing quantization through use of a product of the quantization parameter multiplied by the quantization step value.

7. The image data compression apparatus according to claim 1, further comprising a discrete cosine transform section supplying the image data subjected to discrete cosine transform to the quantization section in frame units.

8. The image data compression apparatus according to claim 1, further comprising:
a hardware processing section processing image data of a dynamic image through hardware; and
a software processing section generating encoded data by encoding quantization data, which is read from the FIFO buffer section, through software, wherein:
the hardware processing section comprises the quantization section and the FIFO buffer section; and
the software processing section comprises the encoded data generating section and the rate control section.

9. The image data compression apparatus according to claim 8, wherein:
the hardware processing section outputs a differential between input image data of the current frame and past image data, which is preceding the current frame by one frame, as dynamic vector information;
discrete cosine transform is performed with respect to the dynamic vector information and outputted as the image data to the quantization section; and
the past image data is generated based on inverse quantization data obtained by inversely quantizing through the quantization step with respect to the quantization data.

10. The image data compression apparatus according to claim 9, wherein:
the software processing section encodes quantization data read from the FIFO buffer section into a variable-length encode.

11. The image data compression apparatus according to claim 10, wherein:
the software processing section performs scanning for permutating quantization data read from the FIFO buffer section and encoding a result of the scanning into a variable-length encode.

12. The image data compression apparatus according to claim 11, wherein:
the software processing section obtains a DC component and an AC component from the quantization data read from the FIFO buffer section, performs scanning for permutating the DC component and the AC component, and encoding the result of the scanning into the variable-length encode.

13. An encoder performing compression processing of image data comprising:
an image input interface performing interface processing to input image data;
a quantization section quantizing the image data in frame units;
an FIFO buffer section in which quantization data of a portion of a plurality of frames quantized by the quantization section is subjected to buffering; and
a host interface performing interface processing with a host reading quantization data stored in the FIFO buffer section asynchronously with writing in the FIFO buffer section, wherein:
the host obtains a predictive data size of encoded data which is preceding by one frame a data size of quantization data preceding a current frame by the one frame, the quantization section quantizes the data according to a quantization step changed based on the predictive data size.

14. The encoder according to claim 13, further comprising a count register wherein count data corresponding to a number of times of accessing the FIFO buffer section is held, wherein:
the host reads the count data held in the count register; and the predictive data size is obtained from the count data.

15. Electronic equipment comprising the image data compression apparatus according to claim 1.

16. The electronic equipment comprising the encoder according to claim 13.

17. An image data compression method for compressing image data, and quantization data in which image data is quantized in frame units, obtaining a predictive data size of encoded data, which is preceding by a frame, from a data size of quantization data preceding a current frame by the one frame;
changing a quantization step for quantizing the image data based on the predictive data size;
quantizing the image data of the current frame by the quantization step; and
changing the data size of the encoded data which encoded the image data.
